(19) United States
(12) Patent Application Publication
(10) Pub. No.: US 2024/0388584 A1
(43) Pub. Date: Nov. 21, 2024

(54) MANAGED APPLICATION OBJECTS

(71) Applicant: Snowflake Inc., Bozeman, MT (US)

(72) Inventors: Damien Carru, New York, NY (US); Benoit Dageville, San Mateo, CA (US); Scott C. Gray, Richmond Hill (CA); Unmesh Jagtap, San Mateo, CA (US); Subramanian Muralidhar, Mercer Island, WA (US); James Pan, Oakville (CA)

(21) Appl. No.: 18/317,370

(22) Filed: May 15, 2023

(51) Int. Cl. H04L 9/40; G06F 8/61; G06F 8/65

(52) U.S. Cl. CPC H04L 63/102; G06F 8/61; G06F 8/65

(57) ABSTRACT

An application package and application instance for a data platform. The application is created in a consumer account of a consumer using the application package. The consumer grants permissions for performing privileged actions in the consumer account to an application role of the application. The application creates objects in the application, creates objects outside of the application in the consumer account, and accesses external systems using permissions granted by the consumer.

### TECHNICAL FIELD

Examples of the disclosure relate generally to databases and, more specifically, to granting permission to applications of a data platform.

### BACKGROUND

Data platforms are widely used for data storage and data access in computing and communication contexts. Providers use the data platform to provide applications to consumers of the data platform. Consumers need methodologies to manage the applications provided to the consumers by the providers.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider system, in accordance with some examples.

FIG. 2 is a block diagram illustrating components of a compute service manager, in accordance with some examples.

FIG. 3 is a block diagram illustrating components of an execution platform, in accordance with some examples.

FIG. 4A is an illustration of an application package and an instantiation of the application package, in accordance with some examples.

FIG. 4B is a sequence diagram of interactions between components of a data platform, in accordance with some examples.

FIG. 4C is an activity diagram of a method of a data platform, in accordance with some examples.

FIG. 5 illustrates a diagrammatic representation of a machine in the form of a computer system within which a set of instructions may be executed for causing the machine to perform any one or more of the methodologies discussed herein, in accordance with some examples.

### DETAILED DESCRIPTION

A data platform proprietor provides a data platform that is used by data providers and data consumers. A provider defines an application package that is owned by a provider account of the provider. The application package is used to instantiate an application that is owned by a consumer account of the consumer. The application may create and use one or more objects within the consumer account. The application may also communicate with one or more external systems.

The consumer and the data platform proprietor have an interest in ensuring that the application does not behave in a malicious manner during execution. The provider has an interest in their application being marketed and properly installed. For example, a provider, such as an Independent Software Vendor (ISVs) or system integrator, distributes an application on a marketplace of the data platform proprietor. The provider may be a data application provider, a data broker, a data monetizer or the like who is more used to vending data services rather than software. Providers may be further classified as:
Developers who develop and maintain application functionality and create application packaging and deployment scripts.
QA team members who perform end-to-end testing of application installation and database functionality.
Release management team members who are responsible for CI/CD pipeline, releases code to different SDLC environments such as QA/UAT/PROD.
Business users who create, update, and publish listings in a production environment.
Support engineers and personnel who allow providers to support their applications in production.

Consumers are customers of the data platform proprietor and they consume applications from the marketplace. Consumers may be further classified as:
Developers, data engineers, and data scientists who integrate installed applications into their logic.
Business users such as analysts who use the application functionality.
Application owners who own and manage permissions for an application including installing an application such as, but not limited to, account administrators.

The data platform proprietor provides marketplace operations, product security, and abuse mitigation. Responsibilities for the data platform proprietor include:
Marketplace operations such as reviewing and approving deployment on the marketplace.
Mitigating risks by:
   not allowing any provider that poses undue risk or is not a fit for the marketplace,
   ensuring profiles and listing content comply with marketplace guidelines,
   performing functional reviews to ensure that an application functions and is usable as a consumer,
   ensuring the application does not contain abusive content or put consumer or provider accounts at risk by reviewing the application against a manifest as well as performing static and dynamic analysis on the code of the application, and
   regularly monitoring applications for abusive behavior after the application is published in the marketplace.

During operation, an application may create objects outside the application. Some of these objects of the application may be made visible selectively to a consumer albeit an account administrator of the consumer account can see everything. For example, an application uses an external function for its internal implementation and needs an API integration so that the application may create a database in the consumer account to copy data into the new database from an external system. In a further example, an application may access existing objects in the consumer account anytime the application is used such as an enrichment application needing select and update permissions on a table in the consumer account to read the consumer data and update that table with enriched values. In a further example, an app needs permissions at account level for operations performed by the application such as an application needing an execute task permissions to execute ingestion logic for a connector application at scheduled intervals.

Methodologies in accordance with this disclosure allow a provider to create an application that is used by a consumer where the consumer controls what kind of operations the application can perform.

An application is a form of a database and comprises a local state and code. The local state exists per application instance and includes an internal state comprising configuration tables, cached data that can be created and updated at runtime by the application, and the like. A local state is mutable and like shared content, it is not versioned either. The code comprises database code artifacts such as views, functions, stored procedures, and the like that are local to an application. Unlike local and shared content, the code is versioned.

The application also has access to shared content comprising provider artifacts such as, but not limited to, tables and named file locations that are accessible in a read-only manner by all application instances. Shared content may be modified by the provider of the application package but not by the consumer. The shared content is not versioned.

Objects created or accessed by the application are sensitive in use of the objects may allow for data egress from the consumer. Accordingly, a data platform provides the ability to review and approve objects created and accessed by the application.

In some examples, a data platform receives from a provider, a definition of an application package of a provider account of the provider. The data platform receives, from a consumer, a request for an application installation of an application using the application package, where the application will be installed in a consumer account of the consumer. The data platform creates the application in the consumer account using a setup script and receives from the consumer, a grant of permissions for the application to perform a privileged action in the consumer account.

The data platform authorizes the privileged action by the application using the grant of the permissions, and the application performs the privileged action based on the authorization.

In some examples, an application comprises a database and the application creates objects in the database and creates objects in the consumer account outside of the database using the grant of the permissions. In some examples, the consumer account takes ownership of objects created by the application when the application is dropped.

In some examples, the application includes an Application Programming Interface (API) integration used by the application to access an external system using the grant of the permissions.

In some examples, the application accesses objects of the versioned schema of the application package using the grant of permission.

In some examples, the unversioned schema includes objects that are referenced by the objects of the versioned schema of the application package.

In some examples, the versioned schema includes objects that are updated during an update of the application package.

In some examples, the grant of the permission includes a secret used to access the external system.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

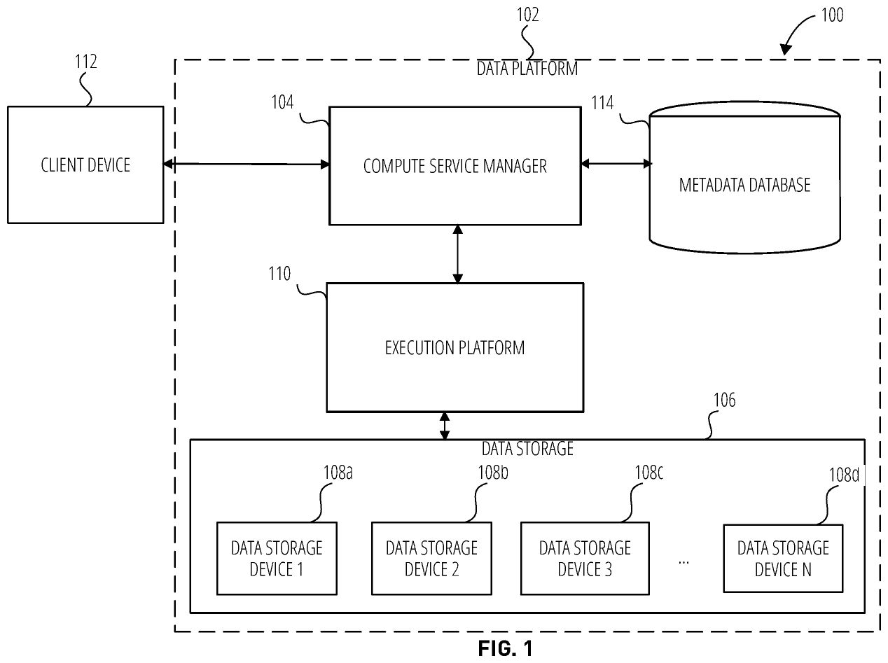

FIG. 1 illustrates an example computing environment 100 that includes a data platform 102 in communication with a client device 112, in accordance with some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage 106, a compute service manager 104, an execution platform 110, and a metadata database 114. The data storage 106 comprises a plurality of computing machines and provides on-demand computer system resources such as data storage and computing power to the data platform 102. As shown, the data storage 106 comprises multiple data storage devices, such as data storage device 1 108a, data storage device 2 108b. data storage device 3 108c. and data storage device N 108d. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters. Amazon S3TM storage systems or any other data storage technology. Additionally, the data storage 106 may include distributed file systems (e.g., Hadoop Distributed File Systems (HDFS)), object storage systems, and the like.

The data platform 102 is used for reporting and analysis of integrated data from one or more disparate sources including the storage devices 1 to N within the data storage 106. The data platform 102 hosts and provides data reporting and analysis services to multiple consumer accounts. Administrative users can create and manage identities (e.g., users, roles, and groups) and use permissions to allow or deny access to identities to resources and services. Generally, the data platform 102 maintains numerous consumer accounts for numerous respective consumers. The data platform 102 maintains each consumer account in one or more storage devices of the data storage 106. Moreover, the data platform 102 may maintain metadata associated with the consumer accounts in the metadata database 114. Each consumer account includes multiple objects with examples including users, roles, permissions, named storage locations, and the like.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests. system administrators managing the systems and methods described herein, and other components/devices that interact with compute service manager 104. As an example, the compute service manager 104 is in communication with the client device 112. The client device 112 can be used by a user of one of the multiple consumer accounts supported by the data platform 102 to interact with and utilize the functionality of the data platform 102. In some examples, the compute service manager 104 does not receive any direct communications from the client device 112 and only receives communications concerning jobs from a queue within the data platform 102.

The compute service manager 104 is also coupled to metadata database 114. The metadata database 114 stores data pertaining to various functions and aspects associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the database storage 106) and the local caches. In some examples, the metadata database 114 includes data of metrics describing usage and access by providers and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the database storage 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle all communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 1 108a to data storage device N 108d are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata database 114, execution platform 110, and data storage 106 are shown in FIG. 1 as individual discrete components. However, each of the compute service manager 104, metadata database 114, execution platform 110, and data storage 106 may be implemented as a distributed system (e.g., distributed across multiple systems/platforms at multiple geographic locations). Additionally, each of the compute service manager 104, metadata database 114, execution platform 110, and data storage 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage 106. It is desirable to retrieve as much data as possible from caches within the execution platform 110 because the retrieval speed is typically faster than retrieving data from the data storage 106.

As shown in FIG. 1, the computing environment 100 separates the execution platform 110 from the data storage 106. In this arrangement, the processing resources and cache resources in the execution platform 110 operate independently of the database storage devices data storage device 1 108a to data storage device N 108d in the data storage 106. Thus, the computing resources and cache resources are not restricted to a specific one of the data storage device 1 108a to data storage device N 108d. Instead, all computing resources and all cache resources may retrieve data from, and store data to, any of the data storage resources in the data storage 106

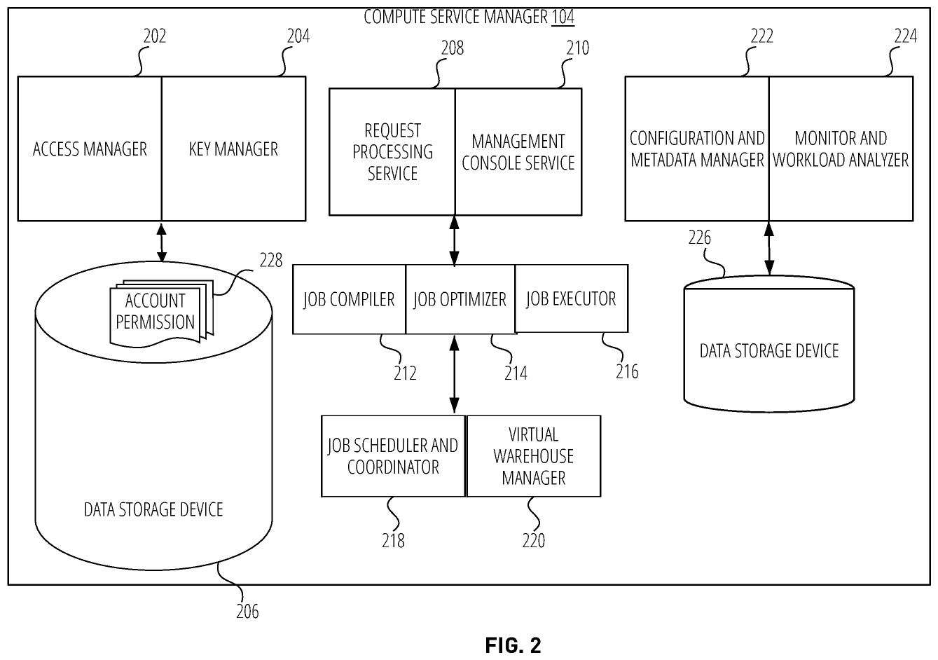

FIG. 2 is a block diagram illustrating components of the compute service manager 104, in accordance with some examples. As shown in FIG. 2, the compute service manager 104 includes an access manager 202 and a key manager 204 coupled to a data storage device 206. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 106). As used herein, the remote storage devices may also be referred to as “persistent storage devices” or “shared storage devices.”

In some examples, the access manager 202 authorizes access to objects of the data platform 102 based on one or more sets of access permissions stored on the data storage device 206, such as a set of account permissions 228.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example. jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage 106, or any other storage device.

The compute service manager 104 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 1 304a) may need to communicate with another execution node (e.g., execution node 2 304b), and should be disallowed from communicating with a third execution node (e.g., execution node 1 316a) and any such illicit communication can be recorded (e.g., in a log or other location). Also, the information stored on a given execution node is restricted to data relevant to the current query and any other data is unusable, rendered so by destruction or encryption where the key is unavailable.

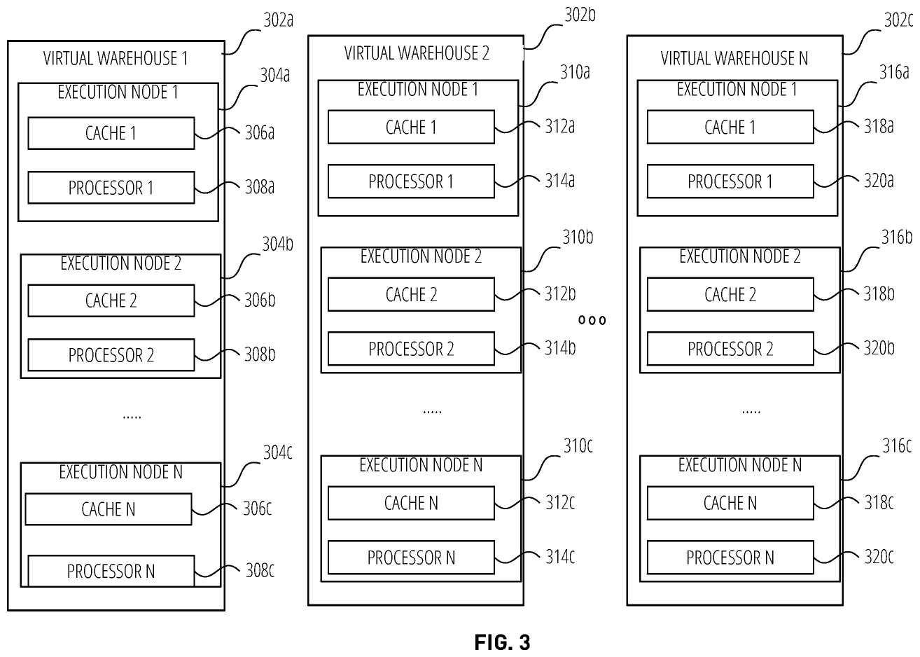

FIG. 3 is a block diagram illustrating components of the execution platform 110 (of FIG. 1), in accordance with some examples. As shown in FIG. 3, the execution platform 110 includes multiple virtual warehouses, including virtual warehouse 1 302a, and virtual warehouse 2 302b to virtual warehouse N 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in data storage 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 1 302a includes a plurality of execution nodes as exemplified by execution node 1 304a, execution node 2 304b, and execution node N 304c. Execution node 1 304a includes cache 1 306a and a processor 1 308a. Execution node 2 304b includes cache 2 306b and processor 2 308b. Execution node N 304c includes cache N 306c and processor N 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 302a discussed above, virtual warehouse 2 302b includes a plurality of execution nodes as exemplified by execution node 1 310a, execution node 2 310b. and execution node N 310c. Execution node 1 310a includes cache 1 312a and processor 1 314a. Execution node 2 310b includes cache 2 312b and processor 2 314b. Execution node N 310c includes cache N 312c and processor N 314c. Additionally, virtual warehouse N 302c includes a plurality of execution nodes as exemplified by execution node 1 316a, execution node 2 316b. and execution node N 316c. Execution node 1 316a includes cache 1 318a and processor 1 320a. Execution node 2 316b includes cache 2 318b and processor 2 320b. Execution node N 316c includes cache N 318c and processor N 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 1 302a implements execution node 1 304a and execution node 2 304b on one computing platform at a geographic location and implements execution node N 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

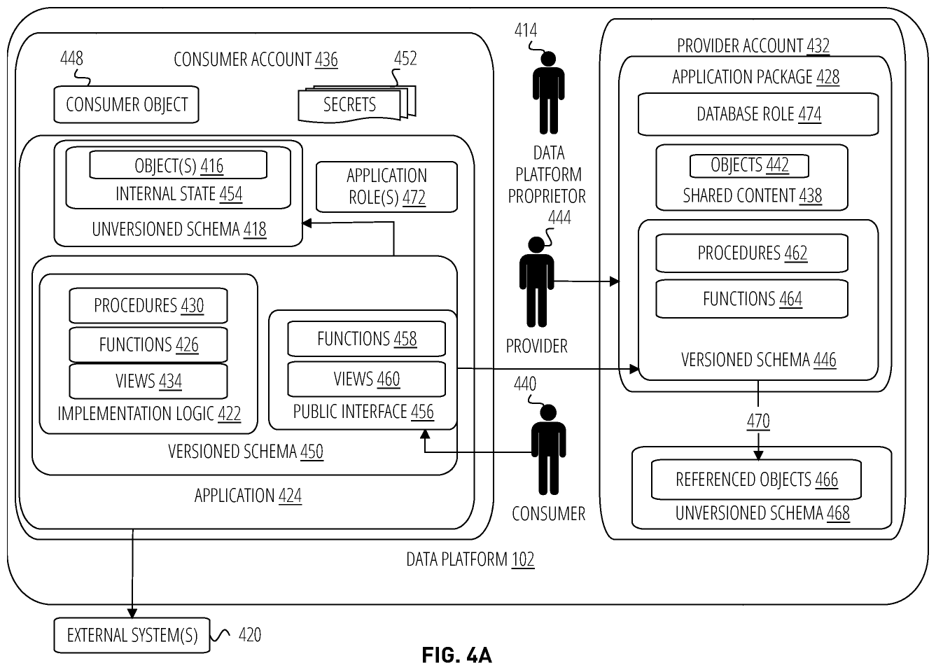

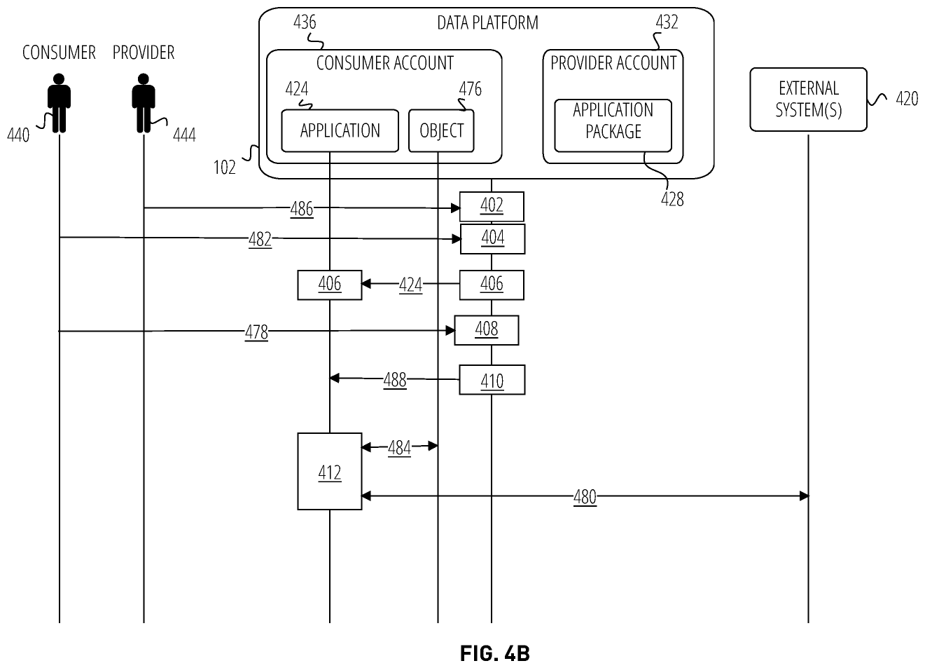

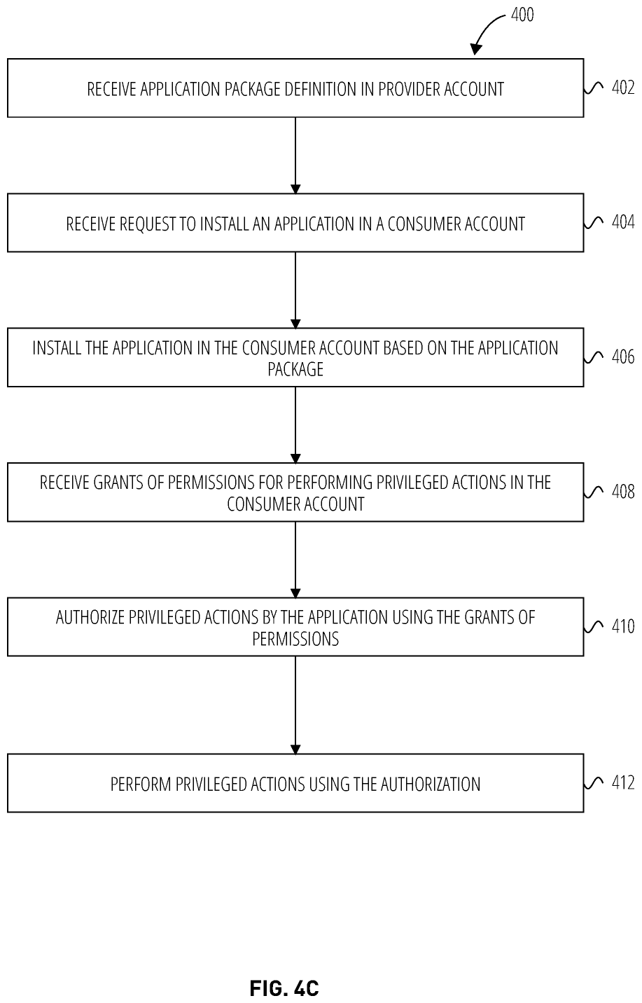

FIG. 4A is a collaboration diagram of a consumer account and a provider account of a data platform, in accordance with some examples. A data platform proprietor 414 provides a data platform 102 that is used by one or more data providers, such as provider 444, and one or more data consumers, such as consumer 440. The provider 444 defines an application package 428 that is owned by a provider account 432 of the provider 444. The application package 428 is used to instantiate an application 424 that is owned by a consumer account 436 of the consumer 440. In some examples, the application 424 creates and uses one or more objects, such as object 476, within the consumer account 436. In some examples, the application 424 communicates with one or more external systems 420.

In some examples the data platform 102 provides for the use of one or more application roles 472 that can be granted specific permissions and access to specific credentials or secrets 452. The provider 444 specifies the roles that are to be created. Once the roles are created, the application 424 uses the one or more application roles 472 to access proprietary data contained in one or more consumer objects 448 of the consumer 440 and access one or more external systems 420.

In some examples, the consumer 440 creates an application package for use by the agents or clients of the consumer 440, that is the consumer 440 acts as a provider. In these examples, the consumer 440 may want to deploy an instance of an application package in such a way that access to the application instance is controlled by the consumer 440 using the one or more application roles 472. FIG. 4B is a sequence diagram of interactions between components of a data platform and FIG. 4C is an activity diagram of the interactions, in accordance with some examples. A compute service manager 104 (of FIG. 1) of the data platform 102 uses the application method 400 to receive a definition of an application package 428 from a provider 444, deploy an application 424 to a consumer account 436 using the application package 428, and provide for grants of permissions by the consumer 440 via the consumer account 436 to the application 424. The data platform 102 also uses application method 400 to allow the application 424 to create and access objects of the data platform 102 and to access external systems external to the data platform 102 using the granted permissions. Although application method 400 depicts a particular sequence of operations, the sequence may be altered without departing from the scope of the present disclosure. For example, some of the operations depicted may be performed in parallel or in a different sequence that does not materially affect the function of the application method 400. In further examples, different components of the data platform 102 may perform operations of the application method 400 in parallel or sequentially.

In operation 402, the compute service manager 104 receives an application definition 486 of the application package 428 from the provider 444. For example, the provider 444 defines the objects 442 of the shared content 438 and the one or more executable objects of the versioned schema 446 such as, but not limited to, the one or more procedures 462 and the one or more functions 464. An application package is an object type that extends the database capabilities in that an application package object is a database object with added features that specifies application versions and contains shared content 438 accessible to all applications in addition to specified roles. The existing permissions on a database object such as modify, monitor, usage, create schema, create database role, ownership, and the like apply for an application package.

In some examples, the application package is owned by the provider account 432 and inherits one or more permissions to perform actions within the provider account 432.

The application package 428 is used to install or instantiate the application 424 in the consumer account 436. Once instantiated the application 424 can be executed by the consumer 440 in the consumer account 436 and access content of the application package 428 that is shared to the application 424 by the provider account 432 in a secure manner. The shared content 438 includes one or more objects, such as objects 442. In some examples, the consumer 440) can be their own provider, e.g., the consumer 440 can create application packages that are used by users of the consumer account 436. In a similar manner, the provider 444 can be their own consumer, e.g., the provider 444 can create application packages for use by users of the provider account 432.

In some examples, the application package 428 is an object that acts like a database and supports features provided by a database container. For example, use of the application package 428 provides for:
Creation of database roles and schemas.
Supports existing permissions of a database.
A show command that returns database and application package objects; has a column indicating the underlying type of the object (e.g., if it is an application package or a plain database), and does not return properties specific to an application package 428.
A describe database command that returns a list of schemas in the application package 428.
A use database command that sets a current session's database to the application package 428 database.
Support of properties specific to the application package 428 such as, but not limited to setup scripts and the like.
Support commands of: a create application package command to create the application package 428; a drop application package command to delete the application package 428; a show application packages command to return all application package objects in a provider account 432; a describe application package command to return any properties, generic or specific, defined on the application package 428.
Appearing in a systems catalog database view.
A consumer account 436 usage view of the application package 428 view.

The application package 428 comprises one or more definitions of executable objects such as, but not limited to, procedures 462 and functions 464. These executable objects may be written in any suitable programming language such as, but not limited to, Python, SQL, and the like. A versioned schema includes objects that may be changed, such as through an update of the shared content 438, procedures 462, and functions 464. In some examples, versioned schema may contain stateless objects. In some examples, a version definition resides in an internal storage location within the application package 428. In some examples this may be in the form of a schema containing one or more named storage locations.

The application package 428 further comprises shared content 438 comprising one or more data objects, such as objects 442, that constitute objects shared to the application 424 that are accessed and/or operated on by the application 424. In some examples, the application package 428 includes shared content comprising one or more schemas containing objects such as, but not limited to, tables, views, and the like. In some examples, the shared content 438 is accessed by the application 424 based on a set of security protocols.

In some examples, executable objects of the application 424 reference 470 one or more referenced objects 466 of an unversioned schema 468 of the provider account 432. An unversioned schema comprises objects that are not updated when the executable objects of a versioned schema 446 are updated. For example, the application package 428 may provide an application that references one or more data objects of an unversioned schema. The one more data object may comprise data that is to be kept and maintained by the provider 444 for use by the consumer 440. When an update is made to the executable objects of a versioned schema, the data objects of the unversioned schema are persisted throughout the updating process of the executable objects.

In some examples, the application 424 comprises a set of versioned objects of a versioned schema 450) that are created during the instantiation of the application 424. The versioned objects include implementation logic 422 that implements the functions of the application 424. In some examples, the implementation logic 422 comprises one or more functions 426, one or more procedures 430, and one or more views 434, and the like. The versioned objects further comprise a public interface 456 that includes executable objects such as, but not limited to, functions 458 and views 460 that implement one or more interfaces of the application 424.

In some examples, the application 424 further comprises an unversioned schema 418 having objects that are not part of the application package 428 but are instead objects derived from data and programs that are unique to the consumer account 436. In some examples, the unversioned objects are logically located in the consumer account 436 but owned by an application role of the application 424. In some examples, the unversioned objects constitute a local state of the application 424 as it is instantiated and executed within the consumer account 436. In some examples, an application instance includes objects that are created by the setup script from the application package. These objects are not part of the application package and are not derived from the local state of the consumer account.

Roles are used to control access of any object within an application 424, including versioned schema 450 as well as unversioned schema 418 that compose the implementation logic 422 of the application 424 and the one or more objects 442 of the shared content 438 of the application package 428. Application roles may further control access to objects created by the application 424 in the consumer's account 436. For example, if the application 424 has been granted the ability to create databases, when application 424 creates the databases they are not accessible by the consumer 440. However, the application 424 may grant permission to one of its application roles, conveying privileges to the consumer.

In addition, roles are used to control execution of the one or more executable objects of the implementation logic 422 that use the objects of the versioned schema 446 of the application package 428. In some examples, a generic role is a role where the application package 428 is treated as a generic database where any standard objects can be created, and an application role is a role that is defined in a setup script and created in the application 424 during installation or upgrade operations. A role of any type may be owned by the consumer account 436, the provider account 432, or the data platform 102. A role of any type may be either visible or hidden to a consumer account 436, a provider account 432, or the data platform 102. A hidden role is a role that a user of the data platform 102 does not explicitly see and cannot modify but may implicitly use to gain access to or execute an object of the data platform 102.

In some examples, the objects defining an application version such as, but not limited to, a setup script or the like, are located in the same named storage location, under the same root directory allowing the data platform 102 to take a snapshot of that directory when an application version of an application package 428 is being defined, thus ensuring immutability of the binaries the programs that the application 424 relies on for security reasons of consumers. In addition, a provider may be prevented from inadvertently modifying an existing application version of an application package 428 by changing or deleting files from a named storage location modified by the provider. For example, when an application version is added to the application package 428 a directory containing the files are copied to a named storage location in the application package 428. That named storage location is controlled by the data platform 102 and not the provider, accordingly, the provider cannot modify the files in that named storage location and does not have read access to the named storage location; however, the named storage location is visible from the application 424 for that application version in order for the programs defined there to be able to reference libraries and files stored in that named storage location.

In some examples, a show grants command shows information schema and system catalogs views for grants and returns an identification of an application package as the grantee role type and an application package name as a grantee role name.

In some examples, objects that are part of the shared content are able to rely on objects defined inside or outside the application package 428, such as views or external tables. The objects added to the shared content may depend on Role-Based Access Control (RBAC) and owner's rights capabilities in order to be able to use the dependent objects outside of sharing flows.

In some examples, in a context of sharing via the application package 428, additional grants of the dependent object are made to the application package 428 to provide a methodology to ensure a provider is explicitly aware as to what is being shared, directly or indirectly, via the application package 428. In some examples, a provider grants a reference permission on a dependent object to the application package 428 allowing the dependent object to be accessed indirectly via the application package 428, but that object is not visible to the application 424. Reference usage allows an object outside of the application package to be shared with the application instance. This permission may ensure the provider is explicitly aware of what is being shared.

A hidden role (referred to as an application primary role) owns everything in the application 424 and everything in the application runs as that role. An application 424 owns any objects created by a setup script that creates the application 424 instance in the consumer account 436. The setup script runs as this role and, thus, everything created within the application 424 by the setup script is owned by this role. In some examples, application roles are used to grant objects that are created as the hidden role to a consumer.

The consumer 440 may grant permissions to the application 424 to access objects within the consumer's environment that the consumer 440 wants the application to access. Since these permissions are granted to the application 424 all code inside of the application 424 has the permissions that the consumer granted to the application 424. In some examples, a consumer grants permissions to the application. These grants are given to another hidden role (referred to as an application importer role) and that role is granted to a hidden application primary role giving the application access to the consumer objects.

In some examples, the data platform 102 provides show and describe commands to show grants that are exposing objects of the application package 428 to the application 424.

In some examples, there are no restrictions on the types of objects that may reside in the application package database or what roles (database or account level) that may own those objects.

In some examples, the data platform 102 may inactivate or drop an application package. When the application package 428 is dropped, the application package 428 is effectively dropped or made unavailable within the provider account 432. The application 424 remains visible to the consumer 440, but is otherwise inaccessible. Attempts to access the application 424 will result in an error indicating the application package has been removed. The consumer 440 explicitly drops the application 424 to ensure that objects that may be owned by the application 424 have been appropriately transferred to other roles. In some examples, the application package 428 may only be dropped if the application package 428 is not associated with a listing in a marketplace of the data platform 102 provided by the data platform proprietor 414.

In some examples, there are multiple types of roles in the application package 428. As the application package 428 is a database, the provider 444 may want to selectively segment permissions on objects in the database to the roles in the provider account 432. A database role 474 provides such capability. Database roles are not created or accessible by the application 424. An application role 472 provides a way to define the public interface 456 of the application package 428 for the consumer 440. In some examples, there are more than one application roles as the application 424 might expose a different interface for different roles using the application 424.

In some examples, the application roles are defined in a setup SQL script, and each entry is hydrated or provisioned in the application 424. Application roles allow the provider 444 to selectively segment the public interface 456 across multiple roles and expose the objects to the consumer 440) across multiple roles that can be granted to local roles on the consumer side.

In an example, an application allows consumers to 1) lookup the transactions for a given user identification, 2) enrich the data from the consumer account and 3) predict the future transactions for a given user identification. The application uses a proprietary dataset for resolving lookup queries and supporting bulk enrichment operations and for training the model used for predicting future transactions. Some example roles for this application are: 1) There are two database roles defined in the setup script in the application package. The database roles comprise a “pipeline manager” role that is granted to a data engineer managing the data lifecycle of the table through stored procedures operationalizing the pipeline for this dataset with tasks, streams, and the like. A “data scientist” role is granted to a data scientist performing model training on this data for improving the accuracy of the model used by the app for predicting future transactions. There are two application roles defined with the application package (via the application setup SQL script) that expose the public interfaces to the consumers. These application roles are hydrated in the consumer side as database roles. An “enrich” role is granted to a user having access to a lookup and a bulk enrich function and a “predict” role is granted to the user having access to the prediction function.

In some examples, the shared content 438 comprises provider artifacts such as tables that are accessible by application instances. In some examples, objects that comprise the shared content 438 are read-only for application instances. In some examples, only the provider account 432 side can update the shared content 438.

In some examples, specified objects can be granted to the application package 428 such as schemas, tables, views, named storage locations, secrets 452 or credentials for external functions, and the like.

In some examples, tables may not have virtual expressions and policies that rely on executable code. In some examples, restrictions are enforced when the table is granted to the application package 428, when a table that is exposed to the application 424 is modified, as well as at runtime.

Views are used to share objects outside of the application package 428 database. In some examples, views may not have virtual expressions or policies that rely upon executable code.

In some examples, named storage locations may be exposed to the application 424, but may not be referenced by import statements on extension code. Such code may only reference named storage locations that are associated with an application version. In some examples, this feature is disabled by default and parameter protected. The secrets 452 or credentials are used to access external functions provided by one or more external systems 420.

In some examples, the shared content 438 is not exposed to the consumer 440 directly but it is exposed via versioned code artifacts such as views 460. The shared content 438 is exposed to the application package using a grant command.

In some examples, the application provider 444 may want to refactor shared content that is common across different application packages to be outside the definition of any single application package. Other times, reference usage is necessary when there is an existing state that the provider 444 may want to leverage without changing their data pipelines to move this state to an application package. The data platform 102 provides for referenced objects 466 of an unversioned schema 468 for storing such objects. In some examples, the application package 428 references tables or external tables defined outside the application package 428 (but not views, functions or the like).

In some examples, a table of the referenced objects 466 cannot have virtual expressions or policies that rely on executable code. This restriction is enforced when the table is granted to the application package, when a table that is exposed to applications is modified, as well as at runtime.

In some examples, the referenced objects 466 may not come from imported databases (data share or application package). Nor may they refer to objects coming from such imported databases. This restriction is enforced when the table is granted to the application package 428, when a table that is exposed to the application 424 is modified, as well as at runtime.

In some examples, the application package 428 does not expose the referenced objects 466 directly to the consumer 440, but instead indirectly exposes them through a view or table function, such as views 460 and functions 458.

In some examples, access to the referenced objects 466 are granted to the application package 428 in a manner similar to objects in the application package 428 database. In an example, when a referenced object exists in a different database than the application package 428, the referenced object is exposed to the application 424 by granting the permission to the application package 428, permissions are not granted to the application role 472 directly.

The application package 428 comprises one or more files that define an application version. For example, a manifest contains metadata used to bootstrap an application version, help the consumer 440) and the data platform proprietor 414 evaluate the security posture of the application 424 and streamline the management of global permissions required by the application 424 in the consumer account 436. A manifest comprises account level permissions required by the application 424 to create objects in the consumer account 436 and execute operations such as running tasks along with bindings for referencing consumer objects.

To support debugging, the provider 444 can incorporate logging and traces into code artifacts defined in the setup script of an application version. An application framework of the data platform 102 allows the consumer 440 to share application logs with the application provider. The framework also allows the provider 444 to define a default log level for an application package 428, allows the consumer 440 to override the log level of the application 424, and allows a consumer to enable or disable the sharing of logs with the provider 444.

In some examples, the consumer 440 grants permission for the application 424 to create objects that provide external access, however these objects are not usable by the application 424 until the consumer 440 approves their use.

In some examples, functions may not be directly shared from the provider account via the shared content and, thus, external functions are defined in the consumer account 436.

In some examples, the provider 444 creates a named file system that comprises a manifest definition and setup scripts as well as any Java JAR files and Python library files that will be used by the application package 428 to create the application 424. This named file system may be created in any database outside the application package 428 or inside the application package 428.

In operation 404, the compute service manager 104 receives a request 482 from the consumer 440 for installation or instantiation of the application 424 in the consumer account 436. For example, the consumer uses a user interface of the data platform 102 to select an application from a listing of applications in a marketplace of applications provided by the data platform proprietor 414.

In operation 406, the compute service manager 104 installs or instantiates the application 424 in the consumer account 436 based on the definition of the application package 428. For example, the data platform 102 executes a setup script to install the application 424. The setup script deploys logic that comprises the implementation details of the application 424 and a public interface 456 of the application 424. The data platform 102, sets up a local state of the application 424 comprising an unversioned schema 418 including an internal state 454 and one or more objects 416 of the internal state 454. In some examples, the setup script is executed during an upgrade of the application 424. In some examples, one or more objects of the application 424 are instantiated at runtime. In some examples, the application 424 is owned by the consumer account 436.

An example setup script is illustrated below:

CREATE APPLICATION ROLE READONLY;
CREATE APPLICATION ROLE ADMIN;
CREATE SCHEMA IF NOT EXISTS app_state;
CREATE TABLE IF NOT EXISTS config ( param VARCHAR(128),
value VARCHAR(1024), set_on TIMESTAMP );
ALTER TABLE config ADD COLUMN IF NOT EXISTS set_on
TIMESTAMP;
CREATE TABLE IF NOT EXISTS enrich_state ( ... );
GRANT SELECT ON enrich_state TO APPLICATION ROLE
READONLY;
GRANT INSERT, SELECT, UPDATE ON enrich_state TO
APPLICATION ROLE ADMIN;
CREATE SECURE VIEW enrich_source AS SELECT C1, C2 FROM
pkg_state.enrich.source;
GRANT SELECT ON enrich_source TO APPLICATION ROLE
READONLY;

In some examples, the data platform 102 supports a create application command to create a new application instance, a drop application command to drop or delete an application instance, a show applications command that returns all the application objects in the application 424, a describe application command that returns properties, generic or specific, defined on the application 424. In some examples, the application 424 appears in a system catalogs database view and results in a new system catalogs application view.

In some examples, a versioned schema 450 may be created by the setup script, and such a schema is specific to the version of the application package 428 that created it. In contrast, an unversioned schema, such as unversioned schema 418, created by the setup script continues to persist in the application 424 database until explicitly dropped by a later installed version. In some examples, versioned schemas provide a simple way to deploy and manage stateless objects, such as procedures and functions (although any object may be included in them). Because they are effectively cleared out and re-created with each version installation, there is no need for objects within them to be created in an idempotent manner, and there is no need for the provider 444 to keep track of when objects are removed. More specifically, the provider 444 need not worry about the previous state/version of the application 424, whereas with unversioned schema, the provider 444 should be aware of the previous state of the application 424.

In some examples, a local state of the application 424 is comprised of versioned objects of the versioned schema 450 and unversioned objects of the unversioned schema 418 including code artifacts, tables, named storage locations, and the like.

In some examples, a setup script can create any database scoped object such as, but not limited to, a schema, a table, a view, a procedure, and the like, within the application 424.

In some examples, all stored procedures are defined with an “execute as owner” permission level. In some examples, a “secure” keyword is used to cause the stored procedures to execute in a secure manner.

In some examples, there are no restrictions on procedures in versioned schemas creating objects in non-versioned schemas and visa-versa.

In some examples, functions and procedures importing objects from named file locations (such as jars or modules) only refer to files defined by an application version of the application package 428.

In some examples, procedures may not create functions or procedures outside of the application 424 importing from named file locations.

In some examples, the setup script sets up an unversioned schema 418 comprising objects 416 that comprise a local state of the application 424 and deploys code artifacts, such as procedures 430, functions 426, and views 434 of implementation logic 422 and functions 458 and views 460 of the public interface 456. These objects are used by the application 424 as implementation details or exposed to the consumer 440 as a public interface of the application 424. The public interface 456 is defined through the application roles (database roles) directly in the script. The files of the application package 428 further comprise code and binaries that comprise the application logic such as, but not limited to, JAR libraries, Python files for User Defined Functions (UDFs), UDTFs, stored procedures, and the like.

In some examples, the setup script uses a manifest when installing the application 424. The manifest comprises configuration data and metadata used to bootstrap listings and documentation. The manifest is a developer artifact used to describe a version of the application package 428 and its properties. In some examples, the manifest also includes a script locator to describe the path of the script used to set up a given version of the application package 428. In some examples, the manifest comprises version metadata is overridable from the SQL syntax and contains a version which is the literal used to add the version and setup release directives, a label that describes the consumer visible name of the version or a patch, and a comment used to track the version or a patch of the application package 428.

In some examples, the manifest specification comprises metadata of managed objects, such as the objects of the versioned schema 450 and the unversioned schema 418 of the application 424. In some examples, the manifest comprises permissions and bindings, collectively referred to as requirements, that are to be granted or provisioned to the objects of the application 424. An example manifest is illustrated below:

#version identifier version: name: lookupfn_version
label: “Tyrion v1.0”
comment: “lookup user transaction data by userid”
# supported editions: # https://docs.dataplatform.com/en/user-
guide/intro-editions.html#feature-edition-matrix
editions: [EE, BCE]
#artifacts that are distributed from this version of the package
artifacts:
setup_script: scripts/setup.sql
script_languages: [python, scala]
#runtime configuration for this version
configuration:
log_level: debug
event_level: trace
permissions:
EXECUTE TASK: “Permission to run ingestion tasks”
CREATE WAREHOUSE: ″Create warehouse for objects″
CREATE DATABASE: “Create database for ingestion”
CREATE API integration: “Create API integration for endpoints”
CREATE SHARE: ″Create shareback for audience″
references :
enrichment_table: description: ″enrichment source table″
permissions: SELECT
object_type: TABLE
multi_valued: true

In some examples, a manifest comprises a diagnosability component defining a logging and tracing level.

In some examples, a manifest comprises a permission component defining permissions that allow the application 424 to create new objects or execute privileged actions. Example permissions include, but are not limited to, a create database permission, a create datastore permission, create a shared named storage location permission, a create API integration permission, a create external access integration permission, an execute task permission, an execute managed task permission, and the like. In some examples, specifying a permission that falls outside of an enumerated list of permissions will fail.

In some examples, a manifest comprises a bindings component defining a template of object types and the permissions that an application needs at runtime on those objects for application functionality. The provider 444 can verify the declared bindings in their application package version.

In some examples, the consumer 440 sets the bindings during installation of the application 424.

In some examples, consumers can track or audit binding-object associations through show commands as well as audit through object dependencies and access history views.

An example code fragment of use of the application 424 use of the binding is illustrated below:

CREATE PROCEDURE proc( )
LANGUAGE SQL as
BEGIN
SELECT ... FROM BINDING_IDENTIFIER (input_table);
...
my_objects : =
parse_json(SYSTEM$GET_BINDING_ASSOCIATIONS(e_tables’));
for i in 0 to array_size(my_objects) − 1 loop execute immediate
‘create view as... select * from BINDING_IDENTIFIER (‘ | |
my_objects [i] | | ‘)’;
end;
END;

In some examples, the consumer 440) can unset the bindings.

In some examples, the objects that can be bound include, but are not limited to, tables, views, external tables, named storage locations, API integrations, external access integrations, email notification integrations, secrets, and the like.

In some examples, the manifest comprises properties defining languages used by the version of the application package 428. In some examples, the languages list includes Python, Java, Scala, SQL, and the like. In some examples, properties are only specified in the manifest and are not specified after installation of the application 424.

In some examples, not specifying a language will prevent the application 424 from creating or invoking User Defined Extensions (UDXs) in these languages within the application 424. An application 424 can invoke the specified languages owned by the consumer.

In some examples, the consumer has no permissions on objects created within the application 424 and objects created by the application 424 within the consumer account 436 are only visible by an account administrator who may, if they wish, manage or even take ownership of the objects of the application 424. One or more application roles 472 are created in the application 424. In some examples, application roles can only be created in an application (i.e. not in a regular database).

Application roles are similar to database roles, but may only be created within the application database (typically via the setup script) and are automatically granted to the application owner with a grant option. Any permission granted to these roles is thus conveyed to the application owner and the owner may further delegate the roles to other roles within the account. Unlike database roles, application roles may also be granted privileges on objects outside of the application 424 and may therefore be used to grant permissions on objects the application 424 creates back to the consumer 440).

In some examples, the application 424 can determine which objects are exposed to the consumer via Role Based Access Control (RBAC) grants to the one or more application roles 472 of the application 424.

In some examples, the one or more application roles 472 are created by the setup script. In some examples, the application 424 is not granted any permissions declared in the manifest when the setup script is executed.

In some examples, if the application package 428 being installed is in a different account, the consumer 440) needs import listing and create application permissions on the different account as illustrated by the following setup script fragment:

GRANT IMPORT LISTING ON ACCOUNT TO ROLE
<ROLE_NAME>;
CREATE APPLICATION <APP_NAME> FROM
LISTING<LISTING_NAME>...

In some examples, an owning role may drop the application 424 as illustrated by the following code fragment:

DROP APPLICATION <APP_NAME> [ CASCADE | TRANSFER
OWNERSHIP TO <ROLE> ]

If an ownership transfer is specified, any object created by the application in the consumers environment will be transferred to the specified role. If CASCADE is specified, objects owned by the application will be dropped along with the application. If neither CASCADE nor TRANSFER ownership are specified, the application may only be dropped if it does not own objects in the consumer's environment.

In some examples, upon initial installation, a set of permissions that are required by the version of the application 424 that was installed is persisted into the application local state. During an update, the set of required privileges will be updated in the application local state. Accordingly, if an upgrade removes a permission, the permission will be removed from the set of required permissions, but it will not be automatically revoked from the application 424.

In some examples, an application is created having as a set default, no grants of permissions from the consumer 440 via the consumer account 436.

In operation 408, the compute service manager 104 receives, from the consumer 440, one or more specification of grants of permissions 478 to perform one or more corresponding privileged actions in the consumer account 436 by the application 424. For example, the data platform 102 receives one or more commands from the consumer 440 instructing the data platform 102 to grant one or more corresponding grants of permissions to the application 424. Exemplary commands are illustrated in Table 1 below:

TABLE 1
Privilege Management
GRANT CREATE API integration ON ACCOUNT TO <target>
GRANT <privilege> ON ACCOUNT TO APPLICATION <app>
(existing)
REVOKE <privilege> ON ACCOUNT FROM APPLICATION <app>
(existing)
Object Management
SHOW GRANTS TO APPLICATION <app> (existing)
DROP APPLICATION <app> [ CASCADE ]
Authorization / Sign-off
GRANT AUTHORIZE ON ACCOUNT TO <target>
SHOW API ALLOWED PREFIXES IN API integration <name>
ALTER API integration <name> { ENABLE| DISABLE }
API_ALLOWED_PREFIXES = (
<url> [, <url> ... ] );
SHOW ALLOWED_AUTHENTICATION_SECRETS IN API
integration <name>
ALTER API integration name { ENABLE | DISABLE }
AUTHENTICATION_SECRETS= ( <secret> [, <secret> ...] );
SHOW ALLOWED_AUTHENTICATION_INTEGRATIONS IN API
integration <name>
ALTER API integration <name> { ENABLE | DISABLE }
ALLOWED_AUTHORIZATION_INTEGRATIONS = ( <auth>, [,
<auth> ... ] );
SHOW ACCOUNTS IN SHARE<name>
ALTER SHARE app_api { ENABLE | DISABLE } AUTHORIZATION
ACCOUNTS = ( org1.xyzabc );

In some examples, a consumer 440 may request to view of the permissions of the application 424 from the data platform 102. In response, the data platform 102 returns a listing of permissions as illustrated in Table 2:

TABLE 2

| Column | Description |
|---|---|
| app_name | Name of the application |
| privilege | Name of the privileged action requiring the permission. |
| granted_by | The role that granted the permission or NULL if the |
| | permission has not yet been granted |
| granted_on | Time at which the permission was granted to NULL if it |
| | has not yet been granted |
| description | The description of the reason for the permissions as |
| | indicated in the application manifest |
| is_grantable | Y or N, if the callers currently activated roles allow |
| | the granting of this privilege. |

In some examples, the data platform 102 shows all granted permissions including an indication if the application 424 needs the permission currently.

In some examples, when created, the role owning the application 424 is granted all application roles 472 defined by the application package 428. These application roles 472 may then be granted by the role owning the application 424 to any other account roles as needed.

In some examples, all objects within the application 424 are invisible to the consumer 440 except via the permissions that are conveyed directly through these application roles.

In some examples, Application Permissions on Consumer By default the APPLICATION database does not have any permissions in the consumers environment, however the consumer 440 grants the application 424 permissions to objects within environment by granting the permissions directly to the application 424.

In some examples, the data platform 102 provides a mechanism by which the consumer 440 may inspect permissions and bindings objects of the application 424 to understand which ones have or have not yet been fulfilled. For example, a show permissions command allows the consumer 440 to see which permissions have or have not been granted to the application 424 thus showing the permissions and grants the application 424 actually needs and whether the grants or permissions have been fulfilled.

In some examples, the data platform 102 provides a service to the application 424 where the application 424 can determine if there are changes made to API integration bindings such as by adding a new API integration, or altering an existing API integration with different URL(s) that are approved by the consumer 440. The return value for this statement is a list of authorized URLs that the application can go through.

In some examples, the data platform 102 provides a service to the application 424 where the application 424 can determine if changes made to a shared named storage location, such as the addition of a new one, or altering an existing shared named storage location with new consumer or provider accounts are approved by the consumer 440. The return value for this statement is a list of authorized accounts added to the shared named storage location.

In some examples, the consumer 440 provides grants of permissions on one or more classes of privileged actions performed by the application 424. These privileged actions include. but are not limited to, the application 424 accessing an external endpoint, such as an URL of an external system 420; the application 424 using global permissions in the consumer account 436 to perform privileged actions; the application 424 sharing some data back with the provider account 432 or other accounts of the organization of the consumer 440); and the like.

In some examples, account level permissions are declared and granted to the application 424 after the application 424 is installed. The application 424 does not request new account level permissions during the application runtime as the data platform 102 does not provide this service to the application 424. In some examples, permissions needed by the application 424 are defined in the manifest and are granted to the one or more application roles 472 of the application 424 post setup script execution. Thus the sign off for new account level permissions required by the consumer 440 happen post install.

In some examples, the application 424 creates an API integration with URLs of the one or more external systems 420. The application 424 adds URLs to an API integration (after creation if needed) using the manifest. The application 424 does not add any more URLs to the API integration until it is authorized by consumer 440. Accordingly, the consumer 440 reviews the API integration and the allowed URLs and authorizes the URLs in the API integration. In some examples, the application 424 requests authorization to use the URLs. Once authorized, the application 424 can use the API integration at runtime.

In some examples, the application 424 creates a shared named storage location and adds accounts to the shared named storage location (after creation if needed). The application 424 requests the consumer 440) to authorize the shared named storage location to be shared. At this point the application 424 cannot add any more accounts to the shared named storage location until it is authorized by the consumer. The consumer 440 reviews the shared named storage location and accounts added to the shared named storage location. In some examples, the application 424 raises a notification in a User Interface (UI) of the public interface 456. The consumer 440) authorizes the accounts in the shared named storage location. In some examples, the authorization is only permitted if the application 424 requested authorization. Once authorized, the application 424 can use the shared named storage location at runtime.

In some examples, the application 424 does not create objects until the application 424 has been granted the necessary permissions to do so. Accordingly, the data platform 102 provides a mechanism by which the application is made aware of the fact that it is now permitted to create objects.

In some examples, the application 424 determines that a required permission has not been granted and generates an error message with guidance for granting the required permission. The error message is presented to the consumer 440 using the public interface 456. In some examples, upon determining it has not been granted certain permissions, the application 424 disables aspects of the functions of the application 424 related to the permissions that have not been granted.

In some examples, objects are not visible to consumers unless the setup script explicitly grants permissions to one or more application roles 472.

In some examples, permissions to access the objects 442 of the shared content 438 may not be granted to the application role 472. These objects are exposed through objects defined in the local state of the application 424, such as, but not limited to views 460 of the public interface 456 and views 434 of the implementation logic 422.

In some examples, permissions to access any local object (versioned or unversioned) may be granted to the application role 472.

In some examples, procedures and functions may have direct named file location access (UDF Server Data File Access) to any named file location granted by the consumer 440, any named file location managed in the internal state 454 of the application 424, as well as the logical file reference locations.

In operation 410, the compute service manager 104 authorizes the application 424 to perform one or more privileged actions such as, but not limited to, creation and use of objects on the data platform 102 in the consumer account and access to the external systems 420, using the permissions and bindings granted to the application role. For example, the data platform 102 provides an account level authorize privilege for authorizing privileged actions using permissioned granted to the one or more application roles 472. The account level authorize privilege is granted to a security administrator role by default and is grantable to any other role. The account level authorize privilege allows the consumer 440 to resolve all objects in the consumer account 436 and to execute alteration and authorization operations on objects owned by the application 424. The account level authorize privilege cannot be granted to the application 424.

In some examples, the data platform 102 authorizes the one or more privileged actions using a Role Based Access Control (RBAC) protocol.

In some examples, the account level authorize privilege may be used for more than just the application 424. For example, the account level authorize privilege may be used on API integrations and the like. In some examples, an API integration has multiple attributes that each, individually, may require signoff. These attributes include, but are not limited to, API allowed prefixes that determine the URL prefixes to which a function can connect, secrets that provide identifying information for establishing connections, authentication integrations that require secrets, and the like. In some examples, this information can, indirectly, control what the application 424 is communicating with, so allowing the application to use any secret could allow for exfiltration. The consumer 440 may want to vet that the secret is one the consumer owns, or the consumer 440 may want to simply trust a given secret of the application 424.

In some examples, when an API integration is created by the application 424, it will start in a state in which it exists, but with none of the attributes such as, but not limited to, URLs, credentials, secrets, and the like, used to access one or more external systems 420, that require authorization that have not yet been provided.

In some examples, for API integrations owned by the application 424, upon creation, the API integration that is created will show that the API integration attributes have not been authorized in response to a status request such as by a describe command executed by the consumer 440) or in response to a GET_DLL( ) request. In some examples, if the consumer 440) takes ownership of the API integration, the data platform 102, the data platform 102 will provide the API integration with all of the approved attributes and the unapproved attributes will be lost. In some examples, although an API integration may not have any authorized attributes, the application 424 may still create functions and the API integration will be validated against the unapproved attributes. However, invocation of the function will fail if any of the attributes have not been approved.

In some examples, the application 424 may choose to alter an existing API integration at any time resulting in the following behavior: any new attributes go into a set of unauthorized attributes; any attributes that were removed from a previous definition are removed from a set of authorized attributes and the set of unauthorized attributes. In some examples, if the application 424 attempts to add an attribute at a later time, the addition requires reauthorization.

In some examples, the data platform 102 provides a command allowing discovery of the sign-offs that are required for an API integration. The command may be executed by the object owner or a consumer with an authorize privilege. The command may be executed against any API integration, not just those owned by the application 424.

In some examples, the data platform 102 provides a command for authorizing API integration attributes. Execution of the command authorizing API integration attributes requires an authorize permission on the consumer account 436. Applying the command for authorizing API integration attributes to API integrations not created by the application 424 results in an error. Executing the command for authorizing API integration attributes on an attribute that was not defined in API integration results in an error. Any subset of the attributes specified by the API integration may be authorized.

In some examples, the data platform 102 provides a command for unapproving or deauthorizing attributes of an API integration is provided. The deauthorization may be applied to attributes individually or to all of the attributes of the API integration as a group.

In some examples, the application 424 may create and grant objects to be shared with other accounts following normal RBAC rules, however when an account is set, added, or removed the data platform 102 performs operations similar in behavior to management of API integrations as discussed above. For example, accounts that are added or set initially go into a list of unauthorized accounts and do not appear in an output of a describe command as valid accounts on the shared named storage location. Accounts that are removed are removed from the authorized set of accounts and need to be re-authorized if they are later added back. In some examples, this behavior only applies to shared named storage locations owned by the application 424.

In some examples, if the consumer 440 takes over ownership of the objects shared with other accounts, the shared objects will reflect the accounts that were authorized at the time that ownership was taken.

In some examples, authorizing accounts to which accounts are shared requires an authorization privilege on the consumer account 436. Applying an account authorization to a shared named storage location not created by application 424 results in an error. Authorizing an account that was not defined in the shared named storage location results in an error. Any subset of the accounts specified for the shared named storage location may be authorized. Accounts may also be unapproved.

In some examples, the application 424 can create objects used internally by the application 424 but not exposed to consumers.

In operation 412, the application 424, while executing on the data platform 102, performs one or more privileged actions such as, but not limited to, creating and accessing data 484 of one or more objects in the consumer account 436 and communicating and exchanging data 480 with one or more external systems 420, using the authorization 488. For example, if the application has been granted sufficient permissions in the consumer account 436 of the consumer 440, application 424 can create, access, and drop objects following RBAC rules.

In some examples, the application 424 uses one or more interchange objects to access and exchange data with one or more objects outside of the consumer account 436.

In some examples, the application 424 uses one or more API interchange objects to communicate and exchange data with one or more external systems 420.

In some examples, objects created by the application 424 are in the same namespace as all other objects in the consumer account 436, meaning that the application 424 should be aware that it shares that namespace both with other applications as well as objects created by the application 424, and, additionally, should be prepared for the possibility of multiple instances of the same application to be installed at the same time. In some examples, name collision is avoided using naming conventions, where applications choose to prefix objects they create in a fashion making it unlikely to have collisions with other applications. In some examples, a number of objects is limited, by type, that can be created by an individual application instance.

In some examples, the application 424 can determine to make objects it created outside the application 424 visible to the consumer, and if so, with which privileges.

In some examples, the application 424 can create objects that the consumer 440 can access and own jointly with the application 424.

In some examples, the application 424 can create objects dynamically at usage time.

In some examples, the application 424 can access existing objects in the consumer account 436 both at bootstrap and usage time without leaving the application 424 to execute commands. The provider 444 can declare the account level permissions required by the application 424 needed to perform such operations.

In some examples, the consumer application 424 signs off on privileged actions required by the application 424 for operations such as, but not limited to, external access, global permissions, reverse sharing of data, and the like.

In some examples, the application 424 can continue to degrade in functionality gracefully until consumers approve new account level permissions or changes with data exfiltration risk. An example is a provider URL on an internal API integration changed with an upgrade.

In some examples, the data platform 102 restricts the types of objects the application 424 can create. For example, the data platform 102 may restrict the 424 to creating databases, named file systems, API integrations, and shared named storage locations.

In some examples, for objects that are internal to the application 424, such as but not limited to, an API integration, the application 424 doesn't grant any permissions to the objects to the consumer 440. However, an account administrator of the consumer account 436 may take ownership of these objects via a manage grant privileged action on the consumer account 436.

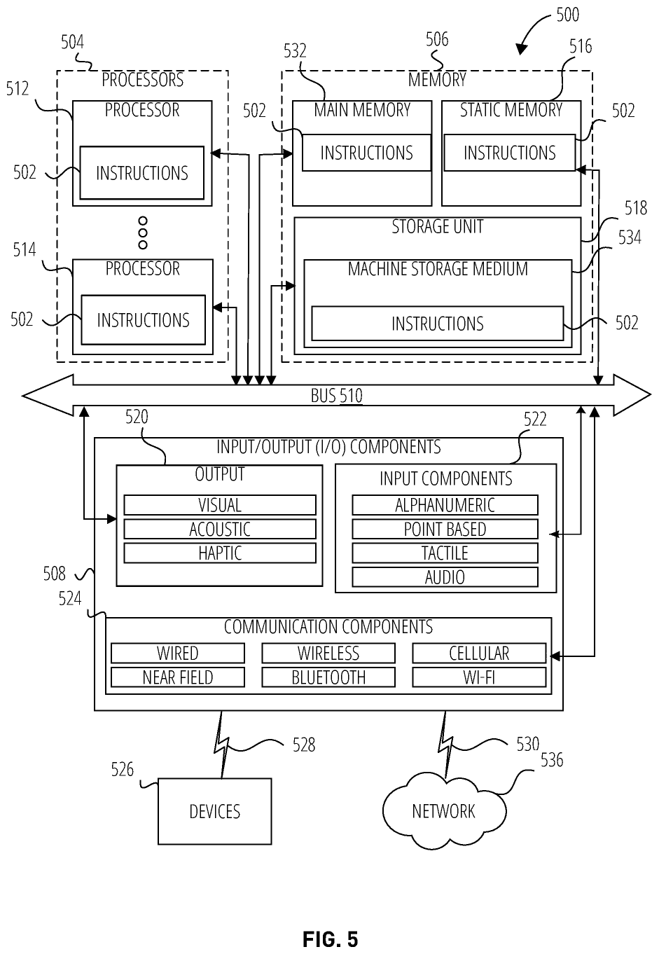

FIG. 5 illustrates a diagrammatic representation of a machine 500 in the form of a computer system within which a set of instructions may be executed for causing the machine 500 to perform any one or more of the methodologies discussed herein, according to examples. Specifically, FIG. 5 shows a diagrammatic representation of the machine 500 in the example form of a computer system, within which instructions 502 (e.g., software, a program, an application, an applet, a data application, or other executable code) for causing the machine 500 to perform any one or more of the methodologies discussed herein may be executed. For example, the instructions 502 may cause the machine 500 to execute any one or more operations of any one or more of the methods described herein. In this way, the instructions 502 transform a general, non-programmed machine into a particular machine 500 (e.g., the compute service manager 104, the execution platform 110, and the data storage devices 1 to N of data storage 106) that is specially configured to carry out any one of the described and illustrated functions in the manner described herein.

In alternative examples, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 502, sequentially or otherwise, that specify actions to be taken by the machine 500. Further, while only a single machine 500 is illustrated, the term “machine” shall also be taken to include a collection of machines that individually or jointly execute the instructions 502 to perform any one or more of the methodologies discussed herein.

The machine 500 includes processors 504, memory 506, and I/O components 508 configured to communicate with each other such as via a bus 510. In some examples, the processors 504 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 512 and a processor 514 that may execute the instructions 502. The term “processor” is intended to include multi-core processors that may comprise two or more independent processors (sometimes referred to as “cores”) that may execute instructions 502 contemporaneously. Although FIG. 5 shows multiple processors 504, the machine 500 may include a single processor with a single core, a single processor with multiple cores (e.g., a multi-core processor), multiple processors with a single core, multiple processors with multiple cores, or any combination thereof.

The memory 506 may include a main memory 532, a static memory 516, and a storage unit 518 including a machine storage medium 534, all accessible to the processors 504 such as via the bus 510. The main memory 532, the static memory 516, and the storage unit 518 store the instructions 502 embodying any one or more of the methodologies or functions described herein. The instructions 502 may also reside, completely or partially, within the main memory 532, within the static memory 516, within the storage unit 518, within at least one of the processors 504 (e.g., within the processor's cache memory), or any suitable combination thereof, during execution thereof by the machine 500.

The input/output (I/O) components 508 include components to receive input, provide output, produce output, transmit information, exchange information, capture measurements, and so on. The specific I/O components 508 that are included in a particular machine 500 will depend on the type of machine. For example, portable machines such as mobile phones will likely include a touch input device or other such input mechanisms, while a headless server machine will likely not include such a touch input device. It will be appreciated that the I/O components 508 may include many other components that are not shown in FIG. 5. The I/O components 508 are grouped according to functionality merely for simplifying the following discussion and the grouping is in no way limiting. In various examples, the I/O components 508 may include output components 520 and input components 522. The output components 520 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 522 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 508 may include communication components 524 operable to couple the machine 500 to a network 536 or devices 526 via a coupling 530 and a coupling 528, respectively. For example, the communication components 524 may include a network interface component or another suitable device to interface with the network 536. In further examples, the communication components 524 may include wired communication components, wireless communication components, cellular communication components, and other communication components to provide communication via other modalities. The devices 526 may be another machine or any of a wide variety of peripheral devices (e.g., a peripheral device coupled via a universal serial bus (USB)). For example, as noted above, the machine 500 may correspond to any one of the compute service manager 104, the execution platform 110, and the devices 526 may include the data storage device 226 or any other computing device described herein as being in communication with the data platform 102 or the data storage 106.

The various memories (e.g., 506, 516, 532, and/or memory of the processor(s) 504 and/or the storage unit 518) may store one or more sets of instructions 502 and data structures (e.g., software) embodying or utilized by any one or more of the methodologies or functions described herein. These instructions 502, when executed by the processor(s) 504, cause various operations to implement the disclosed examples.

Example 1 is a computer-implemented method of a data platform, the method comprising: receiving, by the data platform, from a provider, a definition of an application package of a provider account of the provider, the provider account being provided by the data platform; receiving, by the data platform, from a consumer, a request for an application installation of an application using the application package, the application installed in a consumer account of the consumer, the consumer account provided by the data platform; creating, by the data platform, the application in the consumer account using a setup script; receiving, by the data platform, from the consumer, a grant of a permission for the application to perform a privileged action in the consumer account; authorizing, by the data platform, the privileged action by the application using the grant of the permission; and performing, by the application, the privileged action based on the authorization.

In Example 2, the subject matter of Example 1 wherein the application package comprises an unversioned schema and a versioned schema.

In Example 3, the subject matter of Example 2 wherein the application accesses objects of the versioned schema of the application package using the grant of permission.

In Example 4, the subject matter of Examples 2-3, wherein the unversioned schema comprises objects that are referenced by the objects of the versioned schema of the application package.

In Example 5, the subject matter of Examples 2-4 wherein the versioned schema comprises objects that are updated during an update of the application package.

In Example 6, the subject matter of Examples 1-5 includes, wherein the application comprises a database and the application creates objects in the database using the grant of the permission.

In Example 7, the subject matter of Examples 1-6 wherein the application comprises a database and the application creates objects in the consumer account outside of the application using the grant of the permission.

In Example 8, the subject matter of Examples 1-7 wherein the consumer account takes ownership of objects created by the application when the application is dropped.

In Example 9, the subject matter of Examples 1-8 wherein the application comprises an Application Programming Interface (API) integration used by the application to access an external system using the grant of the permission.

In Example 10, the subject matter of Example 9 wherein the grant of the permission comprises a secret used to access the external system.

Example 11 is at least one machine-readable medium including instructions that, when executed by processing circuitry, cause the processing circuitry to perform operations to implement of any of Examples 1-10.

Example 12 is an apparatus comprising means to implement of any of Examples 1-10.

Example 13 is a system to implement of any of Examples 1-10.

Example 14 is a method to implement of any of Examples 1-10.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage media,” and “device-storage medium” specifically exclude carrier waves, modulated data signals, and other such media, at least some of which are covered under the term “signal medium” discussed below.

In various examples, one or more portions of the network 536 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 536 or a portion of the network 536 may include a wireless or cellular network, and the coupling 530 may be a Code Division Multiple Access (CDMA) connection, a Global System for Mobile communications (GSM) connection, or another type of cellular or wireless coupling. In this example, the coupling 530 may implement any of a variety of types of data transfer technology, such as Single Carrier Radio Transmission Technology (1xRTT). Evolution-Data Optimized (EVDO) technology. General Packet Radio Service (GPRS) technology. Enhanced Data rates for GSM Evolution (EDGE) technology, third Generation Partnership Project (3GPP) including 3G, fourth generation wireless (4G) networks, fifth generation wireless (5G) networks. Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 502 may be transmitted or received over the network 536 using a transmission medium via a network interface device (e.g., a network interface component included in the communication components 524) and utilizing any one of a number of well-known transfer protocols (e.g., hypertext transfer protocol (HTTP)). Similarly, the instructions 502 may be transmitted or received using a transmission medium via the coupling 528 (e.g., a peer-to-peer coupling) to the devices 526. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 502 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A computer-implemented method of a data platform, the method comprising:
receiving, by the data platform, from a provider, a definition of an application package of a provider account of the provider, the provider account being provided by the data platform;
receiving, by the data platform, from a consumer, a request for an application installation of an application using the application package, the application installed in a consumer account of the consumer, the consumer account provided by the data platform;
creating, by the data platform, the application in the consumer account using a setup script;
receiving, by the data platform, from the consumer, a grant of a permission for the application to perform a privileged action in the consumer account;
authorizing, by the data platform, the privileged action by the application using the grant of the permission; and
performing, by the application, the privileged action based on the authorization.

2. The computer-implemented method of claim 1, wherein the application package comprises an unversioned schema and a versioned schema.

3. The computer-implemented method of claim 2, wherein the application accesses objects of the versioned schema of the application package using the grant of permission.

4. The computer-implemented method of claim 2, wherein the unversioned schema comprises objects that are referenced by the objects of the versioned schema of the application package.

5. The computer-implemented method of claim 2, wherein the versioned schema comprises objects that are updated during an update of the application package.

6. The computer-implemented method of claim 1, wherein the application comprises a database and the application creates objects in the database using the grant of the permission.

7. The computer-implemented method of claim 1, wherein the application comprises a database and the application creates objects in the consumer account outside of the application using the grant of the permission.

8. The computer-implemented method of claim 1, wherein the consumer account takes ownership of objects created by the application when the application is dropped.

9. The computer-implemented method of claim 1, wherein the application comprises an Application Programming Interface (API) integration used by the application to access an external system using the grant of the permission.

10. The computer-implemented method of claim 9, wherein the grant of the permission comprises a secret used to access the external system.

11. A data platform comprising:
one or more processors; and
one or more memories storing instructions that, when executed by the one or more processors, cause the one or more processors to perform operations comprising:
receiving, by the data platform, from a provider, a definition of an application package of a provider account of the provider, the provider account being provided by the data platform;
receiving, by the data platform, from a consumer, a request for an application installation of an application using the application package, the application installed in a consumer account of the consumer, the consumer account provided by the data platform;
creating, by the data platform, the application in the consumer account using a setup script;
receiving, by the data platform, from the consumer, a grant of a permission for the application to perform a privileged action in the consumer account;
authorizing, by the data platform, the privileged action by the application using the grant of the permission; and
performing, by the application, the privileged action based on the authorization.

12. The data platform of claim 11, wherein the application package comprises an unversioned schema and a versioned schema.

13. The data platform of claim 12, wherein the application accesses objects of the versioned schema of the application package using the grant of permission.

14. The data platform of claim 12, wherein the unversioned schema comprises objects that are referenced by the objects of the versioned schema of the application package.

15. The data platform of claim 12, wherein the versioned schema comprises objects that are updated during an update of the application package.

16. The data platform of claim 11, wherein the application comprises a database and the application creates objects in the database using the grant of the permission.

17. The data platform of claim 11, wherein the application comprises a database and the application creates objects in the consumer account outside of the application using the grant of the permission.

18. The data platform of claim 11, wherein the consumer account takes ownership of objects created by the application when the application is dropped.

19. The data platform of claim 11, wherein the application comprises an Application Programming Interface (API) integration used by the application to access an external system using the grant of the permission.

20. The data platform of claim 19, wherein the grant of the permission comprises a secret used to access the external system.

21. A machine-storage medium comprising instructions that, when executed by one or more processors of a machine, cause the machine to perform operations comprising:
receiving, by a data platform, from a provider, a definition of an application package of a provider account of the provider, the provider account being provided by the data platform;
receiving, by the data platform, from a consumer, a request for an application installation of an application using the application package, the application installed in a consumer account of the consumer, the consumer account provided by the data platform;
creating, by the data platform, the application in the consumer account using a setup script;
receiving, by the data platform, from the consumer, a grant of a permission for the application to perform a privileged action in the consumer account;
authorizing, by the data platform, the privileged action by the application using the grant of the permission; and
performing, by the application, the privileged action based on the authorization.

22. The machine-storage medium of claim 21, wherein the application package comprises an unversioned schema and a versioned schema.

23. The machine-storage medium of claim 22, wherein the application accesses objects of the versioned schema of the application package using the grant of permission.

24. The machine-storage medium of claim 22, wherein the unversioned schema comprises objects that are referenced by the objects of the versioned schema of the application package.

25. The machine-storage medium of claim 22, wherein the versioned schema comprises objects that are updated during an update of the application package.

26. The machine-storage medium of claim 21, wherein the application comprises a database and the application creates objects in the database using the grant of the permission.

27. The machine-storage medium of claim 21, wherein the application comprises a database and the application creates objects in the consumer account outside of the application using the grant of the permission.

28. The machine-storage medium of claim 21, wherein the consumer account takes ownership of objects created by the application when the application is dropped.

29. The machine-storage medium of claim 21, wherein the application comprises an API integration used by the application to access an external system using the grant of the permission.

30. The machine-storage medium of claim 29, wherein the grant of the permission comprises a secret used to access the external system.
